(19) United States
(12) Patent Application Publication
(10) Pub. No.: US 2013/0191176 A1
(43) Pub. Date: Jul. 25, 2013

(54) METHOD AND DEVICE FOR CO-ORDINATING TWO CONSECUTIVE PRODUCTION STEPS OF A PRODUCTION PROCESS

(71) Applicant: ABB AG, Mannheim (DE)

(72) Inventors: Guido Sand, Weinheim (DE); Chaojun Xu, Mannheim (DE); Iiro Harjunkoski, Weinheim (DE); Sleman Saliba, Heidelberg (DE)

(73) Assignee: ABB AG, Mannheim (DE)

(21) Appl. No.: 13/747,762

(22) Filed: Jan. 23, 2013

Related U.S. Application Data
(63) Continuation of application No. PCT/EP2011/003499, filed on Jul. 13, 2011.

(30) Foreign Application Priority Data
Jul. 23, 2010 (DE) 102010032185.0

(51) Int. Cl. G06Q 10/06

(52) U.S. Cl. CPC G06Q 10/06316
USPC 705/7.26

(57) ABSTRACT

A method and apparatus are disclosed for coordinating two consecutive production steps of a production process including: a) devising a production schedule of a first manufacturing stage according to a first optimization target based on one or more first optimization parameters, in order to obtain a first optimization result; b) devising a production schedule of a second manufacturing stage according to a second optimization target based on one or more second optimization parameters, in order to obtain a second optimization result; c) assessing the optimization results with regard to an overall optimization target; d) modifying the first and second optimization parameters; and e) repeating the process of devising the production schedules of the first and second manufacturing stages according to the respective optimization target based on the modified first and/or second optimization parameters.

### RELATED APPLICATIONS

This application claims priority as a continuation application under 35 U.S.C. §120 to PCT/EP2011/003499, which was filed as an International Application on Jul. 13, 2011 designating the U.S., and which claims priority to German Application 10 2010 032 185.0 filed in Germany on Jul. 23, 2010. The entire contents of these applications are hereby incorporated by reference in their entireties.

### FIELD

The disclosure relates to methods for coordinating, carrying out and operating production processes, for example, production processes for manufacturing metal from raw material, and to methods for optimizing the sequences and working steps of two successive manufacturing stages of a production process.

### BACKGROUND INFORMATION

For the manufacturing of steel and other metals, complex, energy-intensive manufacturing methods can be used, including a number of successive manufacturing stages. In a first manufacturing stage, raw material is introduced into a melting furnace, in which it is melted, freed of impurities and cast into semifinished products, such as slabs or billets. This first manufacturing stage can take place in a smelting plant.

In a second manufacturing stage, the semifinished products can be further processed in a rolling mill, in order to produce a roll or coil of metal of a specific size and specific dimensions. In a final manufacturing stage, the rolls or coils can be subjected to final processing in a cold rolling mill.

The raw material can be processed in batches of a limited batch size of often several tons. A number of these batches can be processed simultaneously in parallel units, a batch not being divided within a manufacturing stage, so that one batch passes through the manufacturing stage as a single entity. In the smelting plant, for example, batches of different types of steel manufactured from scrap and other raw materials are processed in installations of various types. In the smelting plant, each batch is cast and cut into slabs in a method step. The sequence of the method steps in the manufacture of the slabs can be determined by the compatibility of the different types of steel and the width and thickness of the slabs to be cut.

The subsequent manufacturing stage in a hot rolling plant includes a production line with installations for serial further processing. The slabs manufactured in the smelting plant can be rolled in the hot rolling plant into rolls of sheet or coils of a specific thickness, width and length.

A specific method sequence in which a group including a number of slabs or corresponding coils fed from the hot rolling plant is processed is known as a hot rolling program. The sequence of the slabs within a hot rolling program can depend on the thickness and quality of the strands or sheets of the rolls or coils to be manufactured from these slabs.

The production process in the smelting plant follows metallurgical rules, whereas in the hot rolling plant the production process can be subject to physical constraints. One of the manufacturing rules in the smelting plant relates to producing the melts in accordance with steel grades that are compatible with one another. In the final method step of the smelting plant, a number of melts are cast continuously into slabs and then transported to the hot rolling plant, in which they are rolled into rolls of sheets or coils.

A slab can leave the smelting plant at a temperature of approximately 1100° C. in what is known as a hot state. However, the slabs can be processed in the hot rolling mill in a specific sequence according to the hot rolling program. The manufacturing stages, the smelting plant and the hot rolling plant, may not have a coordinated manufacturing schedule, so that the slabs manufactured in the smelting plant may be temporarily stored in a slab store until all the required slabs are ready for a hot rolling program. The uncoordinated manufacturing schedule not only means that a higher storage capacity may be used, but also can lead to a higher energy consumption on account of the reheating of the slabs in a slab furnace before they are fed to the hot rolling stage. The energy consumption can be considerable, because the slabs may have to be heated to a temperature of approximately 1000° C. before they are fed to the hot rolling plant. The transporting of a hot slab from the smelting plant to the hot rolling plant without temporary storage, or only with brief temporary storage, is possible if the schedules in the smelting plant and the hot rolling plant are efficiently coordinated with each other.

Until now, the method sequences of the manufacturing stages in the smelting plant and the hot rolling plant have been planned independently of each other with two independent models. The slab store can be used as a temporary store in order to compensate for the lack of coordination of the method sequences of the two manufacturing stages. This means that storage can involve considerable effort and enormous energy consumption for reheating the slabs.

To optimize the production sequences, with a decentralized setup, one of the two manufacturing stages, either the manufacturing stage of the smelting plant or the manufacturing stage of the hot rolling plant, determines the method sequence of the other manufacturing stage, respectively. This means that first the method sequence of one of the two processes can be optimized in such a way that its production conditions can be satisfied. Then the method sequence of the other manufacturing stage, respectively, can be optimized in such a way that all the production conditions can be satisfied and the specifications of the other manufacturing stage are met.

An issue of this procedure is that the method sequence depends to a considerable extent on the respective working steps. In one case, the method sequence of the hot rolling plant can be initially dependent on the actual orders for rolls, for example, the target output. This gives the input-side specifications for slabs. The schedule for the smelting plant can be created and/or implemented or carried out in dependence on the specifications for slabs, so that it can create or manufacture the number of slabs prescribed by the specifications. Although in the case of this procedure the stock of the slab store is not greatly increased, the scheduling in the smelting plant can be comparatively complex, which can lead to cases of short-term planning. As a result, the potential for optimization remains unused.

If, in another case, the schedule of the smelting plant determines the schedule of the hot rolling plant, the operation of the smelting plant can be designed more efficiently but the management of the slab store and the schedule of the hot rolling plant become more complex.

Furthermore, this decentralized setup does not allow maximizing the hot charging ratio. The hot charging ratio corresponds to the ratio of the number of slabs that can be processed directly from the continuous melting furnace in the hot rolling plant without temporary storage to the total number of slabs to be processed. If the direct hot charge is limited, this can mean that the storage time of the hot slabs in the slab store does not exceed a certain threshold time. The lack of adaptation of the two schedules with regard to the hot charging ratio can be overcome by the slab store, where the slabs are temporarily stored, with the issue that the hot slabs cool down during storage and energy-intensive reheating becomes necessary.

If the hot charging ratio is to be increased or the energy consumption for reheating is to be minimized, there is the possibility of planning all the manufacturing stages jointly in a centralized setup. In the case of such a centralized setup, all the production rules of the manufacturing stages are taken into consideration at the same time and scheduling is devised according to an optimization target. However, scheduling can be made more difficult by the complexity of the production rules in these two manufacturing stages and the exponential growth in the computational effort, depending on the individual production rules and on the optimization target. It can therefore be difficult in practice to devise a feasible schedule with such a centralized setup. Centralized planning systems can also involve high costs of converting established, distributed systems.

### SUMMARY

A method is disclosed for at least one of coordinating and operating two successive manufacturing stages of a production process, the method comprising:

a) devising a production schedule of a first of the manufacturing stages according to a first optimization target based on one or more first optimization parameters, in order to obtain a first optimization result;

b) devising a production schedule of a second of the manufacturing stages according to a second optimization target based on one or more second optimization parameters, in order to obtain a second optimization result;

c) assessing the first and second optimization results with regard to an overall optimization target;

d) modifying the first and second optimization parameters; and

e) repeating the devising of the production schedules of the first and second manufacturing stages according to the respective first and second optimization targets based on at least one of the modified first and second optimization parameters.

An apparatus is disclosed for at least one of coordinating and operating two successive manufacturing stages of a production process, the apparatus comprising: a first processor coupled to a memory, configured to devise a production schedule of a first of the manufacturing stages according to a first optimization target based on one or more first optimization parameters, in order to obtain a first optimization result; a second processor coupled to a memory, configured to devise a production schedule of a second of the manufacturing stages according to a second optimization target based on one or more second optimization parameters, in order to obtain a second optimization result; and a third processor coupled to a memory, configured as a coordination device for assessing the first and second optimization results with regard to an overall optimization target, for modifying the first and second optimization parameters and for repeating the devising of the production schedules of the first and second manufacturing stages according to the respective first and second optimization targets based on the modified first and/or second optimization parameters.

A computer readable medium for non-transitory storing of computer program instructions is disclosed, which when executed by a processor coupled to a memory programmed with the instructions, will configure the processor to:

a) devise a production schedule of a first of the manufacturing stages according to a first optimization target based on one or more first optimization parameters, in order to obtain a first optimization result;

b) devise a production schedule of a second of the manufacturing stages according to a second optimization target based on one or more second optimization parameters, in order to obtain a second optimization result;

c) assess the optimization results with regard to an overall optimization target;

d) modify the first and second optimization parameters; and

e) repeat devising of the production schedules of the first and second manufacturing stages according to the respective first and second optimization targets based on at least one of the modified first and second optimization parameters.

### BRIEF DESCRIPTION OF THE DRAWINGS

Exemplary embodiments of the disclosure are explained in more detail below on the basis of the accompanying drawings, in which:

FIGS. 1a and 1b show schematic block diagrams of methods of exemplary embodiments of the disclosure for coordinating a production process with a number of manufacturing stages;

FIG. 2 shows a flow diagram to illustrate a method of an exemplary embodiment of the disclosure for optimizing the scheduling for a number of successive manufacturing stages of a production process; and

FIG. 3 shows a representation of the processing sequences of a smelting plant stage and a hot rolling stage, with and without a coordination stage for optimizing the production sequences.

### DETAILED DESCRIPTION

Exemplary embodiments of the disclosure can provide improved scheduling, for example, for improved handling and/or for improved operation, of two manufacturing stages of a production process, a variable concerning the temporary storage being optimized as an additional optimization target. For example, the additional optimization target can be that of minimizing the proportion of time semifinished products spend in temporary storage between the two manufacturing stages or that of minimizing the energy consumption for reheating in the slab store.

According to a first exemplary embodiment, a method for coordinating and/or operating or handling two successive manufacturing stages of a production process is provided. The method includes the following steps:

a) devising a production schedule of a first manufacturing stage according to a first optimization target based on one or more first optimization parameters, in order to obtain a first optimization result;

b) devising a production schedule of a second manufacturing stage according to a second optimization target based on one or more second optimization parameters, in order to obtain a second optimization result;

c) assessing the optimization results with regard to an overall optimization target;

d) modifying the first and second optimization parameters; and

e) repeating the process of devising the production schedules of the first and second manufacturing stages according to the respective optimization target based on the modified first and/or second optimization parameters.

In particular, steps c) to e) can be carried out until an abort criterion is satisfied.

One exemplary embodiment of a method according to the disclosure is to devise individual production schedules for the manufacturing stages while providing coordination which intervenes on one occasion or in an iterative manner in one or both of the production sequences, in that one or more of the corresponding optimization parameters is/are amended and renewed devising of the production schedules is carried out.

It can also be provided that the production schedules of the individual manufacturing stages can be changed or extended in order that further optimization parameters can be introduced or in order that the overall optimization target can be taken into consideration better.

In an exemplary embodiment of the method according to the disclosure, the created, optimized schedules can be transferred to the respective process control or process monitoring of the manufacturing stages concerned to be implemented and/or carried out and/or are implemented and carried out.

The above method can provide an advantage in that it can build on the already existing decentralized setup with two separate schedulings (devising of the production schedules) for the manufacturing stages and can carry out improved scheduling merely by providing a coordination process. Furthermore, the coordination stage is robust with respect to errors in the event of failure of the coordination stage, because the decentralized setup described above can be used as a fallback solution. A further exemplary advantage of the above method over the decentralized setup is that both schedulings can have the same priorities. Furthermore, the coordination stage can achieve the effect that the hot charging ratio or the storage time of slabs in the slab store can be reduced as an optimization target, even if this leads to poorer schedulings of the individual manufacturing stages. Furthermore, the above method offers the possibility of upgrading an existing decentralized setup merely by providing a coordination stage. This can be less complex than carrying out complete scheduling according to the centralized setup.

Furthermore, the abort criterion can correspond to a maximum number of times that devising the production schedules is repeated or be determined by a predetermined overall optimization criterion being reached.

According to one exemplary embodiment of the disclosure, a temporary store for receiving intermediate products of the first manufacturing stage can be provided between the manufacturing stages, the second manufacturing stage taking the intermediate products from the temporary store for further processing.

It can be provided that the overall optimization target concerns the number of intermediate products in the temporary store, reducing the average time period during which the intermediate products are temporarily stored in the temporary store, and/or maximizing a ratio that dictates the ratio of the number of intermediate products that can be fed to the second manufacturing stage without temporary storage in the temporary store to the total number of intermediate products manufactured, and/or minimizing the energy consumption for keeping the intermediate products ready.

Furthermore, the optimization parameters can include one or more of the following parameters: a latest completion date for a batch including one or more end products of the second manufacturing stage, the earliest date of availability for a batch, a batch priority, a weighting of one or more of the optimization targets, a preferred sequence of the batch processing, minimum, maximum or desired sizes of specific batch groups, a priority of the end products to be produced, and a predetermined optimization parameter.

According to an exemplary embodiment of the disclosure, the optimizing of the production sequence of the first and second manufacturing stages can be carried out in each case by an optimization method which can be selected from the following group of optimization methods:
a mathematical optimization method, in particular linear programming, non-linear programming, mixed integer programming;
a metaheuristic optimization method, in particular based on an evolutionary algorithm, on a particle swarm algorithm, on a tabu search, on algorithms implemented in neural networks, on methods for variable neighbourhood search and/or on an ant colony algorithm;
a randomized optimization method;
a heuristic method, in particular based on a greedy algorithm, on an insertion heuristic, a construction heuristic and/or a savings heuristic;
a rule-based method; and
a combination of the aforementioned methods.

The modifying of the first and second optimization parameters can be carried out by analyzing the optimization parameters generated up to a specific iteration step or after a number of iteration steps or when there have been a specific number of iteration steps, and the associated production schedules, and on this basis generating new values of the optimization parameters for the next iteration step by predetermined calculation specifications. In particular, the modifying of the first and second optimization parameters can be carried out by applying to the optimization parameter a variable which is predetermined or determined from a process variable of at least one of the manufacturing stages. The application can take place by adding the modification variable to the optimization parameter or multiplying the modification variable by the optimization parameter.

Furthermore, the first manufacturing stage can correspond to a smelting plant process and the second manufacturing stage can correspond to a hot rolling process.

According to an exemplary embodiment of the disclosure, an apparatus for coordinating and/or handling or operating two successive manufacturing stages of a production process is provided, the apparatus including:
a first device for devising a production schedule of a first of the manufacturing stages according to a first optimization target based on one or more first optimization parameters, in order to obtain a first optimization result;
a second device for devising a production schedule of a second of the manufacturing stages according to a second optimization target based on one or more second optimization parameters, in order to obtain a second optimization result;
a coordination device for assessing the optimization results with regard to an overall optimization target, for modifying the first and second optimization parameters; and for repeating the process of devising the production schedules of the first and second manufacturing stages according to the respective optimization target based on the modified first and/or second optimization parameters.

In an exemplary embodiment of the disclosure, an interface device can be provided, which interacts with the respective process control or process monitoring of the process of the respective manufacturing stage or stages, in particular for implementing and carrying out the respectively created optimized schedule.

Accordingly, it can advantageously be provided that, by the interface device, the optimized schedules can be transferred to the respective process control or process monitoring of the manufacturing stages concerned or the respective manufacturing stages to be implemented and/or carried out and/or can be implemented and can be carried out.

According to an exemplary embodiment of the disclosure, a computer program product is provided, containing a computer program which carries out or performs the above method when it is run on a data processing unit.

A method according to an exemplary embodiment of the disclosure is described below on the basis of a production planning process for a metal manufacturing process, in which rolls of metal are manufactured from raw material. The manufacturing process can include a smelting plant process which provides charges of slabs or billets from raw materials such as scrap or ores, and a subsequent hot rolling process, in order to process the provided slabs or billets further into rolls, in particular rolls of sheet, or coils.

However, the method for coordinating and/or implementing or carrying out schedulings of two successive manufacturing stages of a production process is not restricted to the manufacture of rolls of metal or coils but can also be applied to other production processes with two successive manufacturing stages.

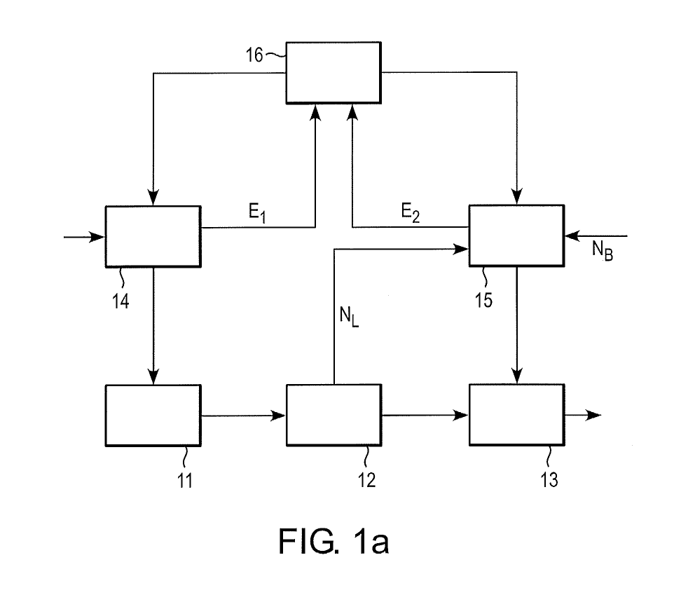

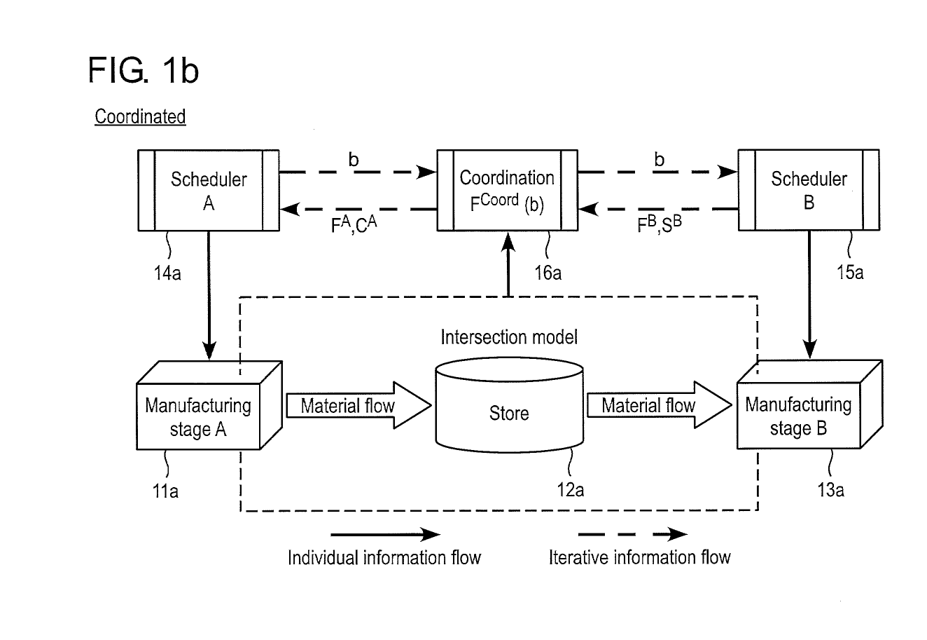

FIG. 1a shows a schematized block diagram of an exemplary embodiment of the disclosure in which the manufacturing stages of the production process and functional blocks for devising and carrying out scheduling for the individual manufacturing stages and a coordination stage for coordinating the schedulings are presented and explained.

As the first manufacturing stage, Figure la shows a smelting plant process 11 which symbolizes the processing of raw material, such as for example metal, ore, scrap and the like, into semifinished products, such as for example slabs, billets and the like. The semifinished products pass through a temporary store 12, from which they are fed to a hot rolling process 13. The hot rolling process symbolizes the further processing of the slabs or billets into rolls or coils of a predetermined type and size. The smelting plant process 11 can be optimized and controlled by a smelting-plant sequence optimization process 14 (first device for devising a production schedule). The hot rolling process 13 can be analogously optimized and controlled by a hot-rolling sequence optimization process 15 (second device for devising a production schedule). In this case, the respective processes can be implemented and/or carried out in interaction with an apparatus according to exemplary embodiments of the disclosure and further technical devices, such as, for example, a smelting plant with blast furnaces and/or a foundry and/or a rolling train, in particular a hot rolling train, with a control center and/or process control.

The smelting-plant sequence optimization process 14 receives as input information from the operator of the system, from an order processing system or in some other way, a statement concerning a group of batches to be processed including one or more slabs. With the aid of one or more mathematical models, such as, for example, linear or mixed integer mathematical programs for the smelting plant process 11, and mathematical optimization algorithms, such as, for example, the simplex method, branch and bound method, branch and cut method or column generation method, the smelting-plant sequence optimization process 14 can deliver a scheduling for the batches that is optimum for predetermined initial optimization parameters, such as, for example, latest delivery dates, and an associated machine allocation plan for the individual processing installations, for example, with the optimization target of minimizing the manufacturing time. As a result of the smelting-plant sequence optimization process 14, a smelting plant optimization result E1 corresponding to the predetermined initial optimization parameters can be obtained.

The input information for the hot-rolling sequence optimization process 15 can include a statement N_{B} of orders for groups of rolls or coils with their physical and metallurgical specifications and a statement of the quantity of slabs or billets in the temporary store 12. With this input information, the hot-rolling sequence optimization process 15 maximizes, according to a further mathematical optimization algorithm and with the aid of predetermined suitable initial optimization parameters, the number of hot rolling programs, which respectively specify a number of slabs or billets in a specific sequence, so that the complex manufacturing rules of the hot rolling process are satisfied. The number of slabs or billets corresponds to the rolls of sheet to be produced if each slab corresponds exactly to one roll to be manufactured. The assignment of slabs to rolls can be changed during the planning process. The number of slabs can, however, also be greater than the number of rolls to be manufactured, if a number of slabs are processed into one roll. At the same time, the sequence of slabs in each hot rolling program is stipulated by the hot rolling optimization process 15. As a result of the hot-rolling sequence optimization process 15, a hot rolling optimization result E2 corresponding to the predetermined initial optimization parameters can be obtained.

Also provided is a coordination process 16, which obtains the optimization results E1 and E2 from the sequence optimization processes 14, 15 and assesses them according to predetermined higher-level optimization targets, while the sequence optimization processes 14, 15 operate separately. The coordination process 16 can trigger the sequence optimization processes 14, 15 for a renewed optimization run with one or more amended optimization parameters. In this way, the overall optimization target can be improved by varying the optimization parameters of the sequence optimization processes 14, 15 without changing the nature of the predetermined optimization targets.

It can be assumed here that the respective manufacturing stage H14 respectively includes a number of production steps PR1 to PRn and the respective manufacturing stage H15 respectively includes a number of production steps SR1 to SRn, and each semifinished product has to run through these.

The modified optimizationparameters a′ and b′ are formed by a third optimization process of a simplified optimization target with regard to the transition from a final production step PRn of the manufacturing stage H14 to the first production step SR1 of the following manufacturing stage H15, so that two successive production steps can be taken into account and/or considered.

For this purpose, it can advantageously be provided that, on the basis of the relevant transition information of the production schedules of two successive manufacturing stages H14, H15 and/or the determined first and second optimization results and/or schedules as well as the target specifications or target function values of the respective manufacturing stage H14, H15 and relevant optimization processes, an abstracted MILP (Mixed Integer Linear Programming) transition planning model is devised in an automated manner for an optimized transition between the two manufacturing stages H14, H15 and the respective underlying optimization target or the corresponding optimization task is accomplished.

The modified first and second optimization parameters a′, b′ resulting from the coordination process 16 can then be transferred back into the optimization model of the respective manufacturing stages H14, H15 involved in the transition and, on this basis, an optimized production schedule of the respective manufacturing stages can be newly devised according to the predetermined optimization target on the basis of one or more optimization parameters to obtain an improved optimization result.

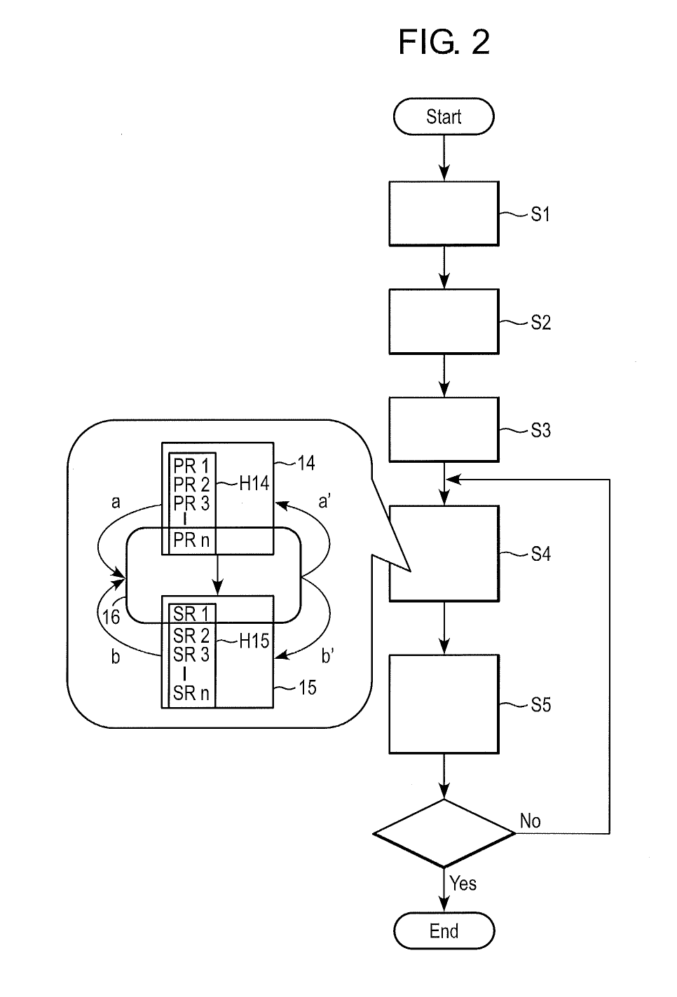

The flow diagram of FIG. 2 shows a method sequence which represents the procedure of the coordination process 16. First, the sequence optimization processes 14, 15 are executed independently of each other in step S1, in order to obtain a smelting plant optimization result E1 and a hot rolling optimization result E2.

In step S2, the coordination process 16 analyzes a smelting plant optimization result E1 provided by the smelting-plant sequence optimization process 14, such as, for example, a batch plan, and the hot rolling optimization result E2 provided by the hot rolling optimization process 15, for example, information on the hot rolling programs. The coordination process can then determine on the basis of the optimization results E1, E2 a variable that is the subject of an overall optimization target.

A possible overall optimization target can be, for example, optimizing (maximizing) the hot charging ratio. The hot charging ratio gives the ratio of the number of slabs or billets (semifinished products) that can be provided directly from the output of the smelting plant process to the downstream hot rolling process 13 without having to be temporarily stored in the temporary store 12 to the number of slabs or billets provided in total by the smelting plant process 1. The hot charging ratio can also consider those slabs or billets that have been temporarily stored in the temporary store 12 for less than a predetermined time period as having been provided directly to the hot rolling process. The time period is chosen such that it dictates the time during which the slabs or billets do not cool down significantly, i.e., not below the further processing temperature in the hot rolling process.

In step S3, with the aid of heuristic methods, critical batch plans are identified as smelting plant optimization result E1 of the smelting-plant sequence optimization process 14 and critical hot rolling programs are identified as hot rolling optimization result E2 of the hot-rolling sequence optimization process 15.

Furthermore, in step S4, the coordination process 16 modifies in one or both sequence optimization processes 14, 15 those initial optimization parameters that mathematically relate to the identified critical parts of the optimization results of the sequence optimization processes 14, 15 into modified optimization parameters. This can involve, for example, setting or predetermining the latest completion date for a batch including one or more slabs, the earliest date of availability for a batch, batch priorities, weightings of the optimization targets, preferred sequences of the batch processing, minimum, maximum or desired sizes of specific groups of batches, priorities of the coils or sheets to be produced in the hot rolling mill, optimization parameters for the forming of the hot rolling programs from slabs, and so on.

A corresponding sequence is also shown in FIG. 1B. The modified optimization parameters b are formed by a third optimization process of a simplified optimization target with regard to the transition from a final production step of the manufacturing stage 11a to the first production step of the following manufacturing stage 13a, so that two successive production steps can be taken into account and/or considered.

The input information for the optimization process 15 can include, for example, a statement of orders for groups of products with their physical and metallurgical specifications and a statement of the amount of semifinished products in a temporary store 12a.

For this purpose, it can advantageously be provided that, on the basis of the relevant transition information of the production schedules of two successive manufacturing stages 11a, 13a and/or the determined first and second optimization results and/or schedules C^{A,} S^{B} as well as the target specifications or target functions F^{A}, F^{B} of the respective manufacturing stage 11a, 13a and relevant optimization processes 14a and 15a, an abstracted transition planning model can be devised in an automated manner for an optimized transition between the two manufacturing stages 11a, 13a and the respective underlying optimization target or the corresponding optimization task, for example, as few semifinished products as possible in the temporary store and/or a high run-through rate, can be accomplished.

The modified optimization parameters b resulting from the coordination process 16a can then be transferred back into the optimization model 14a, 15a of the respective manufacturing stages 11a, 11b involved in the transition and, on the basis, an optimized production schedule of the respective manufacturing stages 11a, 13a can be newly devised according to the predetermined optimization target on the basis of one or more optimization parameters to obtain an improved optimization result.

The sequence optimization processes 14a, 15a can then be activated by the coordination process 16a for renewed optimization of the process 11a and the subsequent process 13a with the modified optimization parameters, in order to achieve an improvement according to the overall optimization target and/or improve the average storage time in the temporary store 12a.

A further modification of the respective optimization parameters can also be determined with the aid of a modification variable by addition or multiplication. The modification variable can be a predetermined variable which, for example, brings about a minor amendment of the optimization parameter concerned in order to realize an iterative method. Alternatively, the modification variable can also be calculated in dependence on a process variable of the assigned manufacturing stage.

The sequence optimization processes 14, 15 are activated by the coordination process 16 for renewed optimization of the smelting plant process 11 and the hot rolling process 13 with the modified optimization parameters, in order to obtain an improvement in the hot charging ratio according to the overall optimization target and/or the average storage time in the temporary store 12. With the aid of the optimization parameters modified by the coordination process 16, in step S5 the smelting plant optimization process devises a new batch plan. At essentially the same time or at a different time, the hot-rolling sequence optimization process 15 implements the process of composing the hot rolling programs in dependence on the modified optimization parameters.

In contrast to decentralized scheduling, the coordination is not a directed process, because the optimization results are not stipulated in the production conditions. The coordination process 16 is executed iteratively. In step S6, it is enquired whether the result of the coordination satisfies a predetermined criterion according to the overall optimization target or the number of iterations exceeds a specific limitation. If this is the case (alternative: yes), no further iteration is executed and the method is ended. Otherwise (alternative: no), the process returns to step S4.

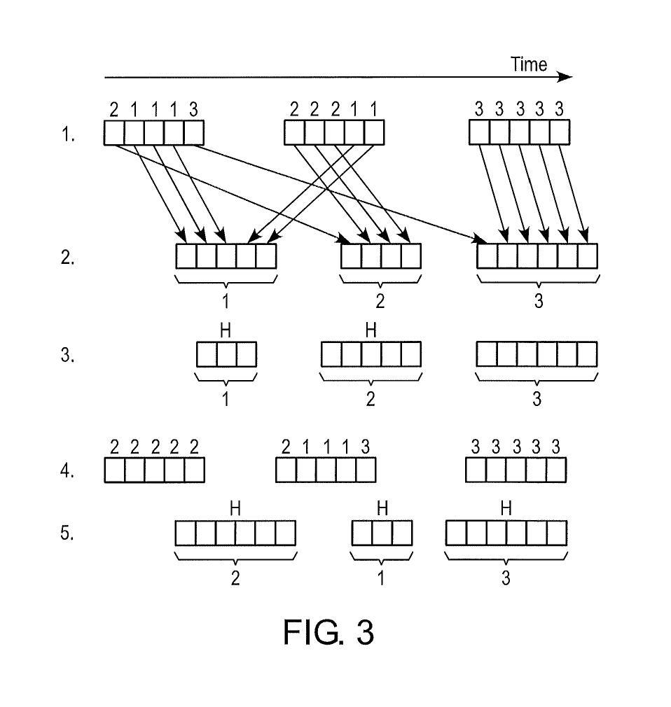

FIG. 3 shows an actual example of the manufacture of rolls or coils of metal from raw material. It illustrates how the hot charging ratio can be improved with the aid of the coordination process 16. It is assumed that the smelting-plant sequence optimization process 14 stipulates the schedule, so that a specific amount of batches is divided into specific batch groups. A first batch group is manufactured first, then a second and a third batch group. Each batch group includes five batches (see line 1). Each batch includes a number of slabs that are subsequently to be rolled in the hot rolling process with various hot rolling programs (see line 2). The relationship between the slabs in the batches and the slabs in the hot rolling programs is represented by the numbers “1”, “2”, “3” and the arrows. For example, the first batch in the first batch group is used in the hot rolling program 2, the subsequent three batches are used for the hot rolling program 1 and the last batch is used for the hot rolling program 3. This relationship between the batch and the hot rolling programs is the result of the hot-rolling sequence optimization process 14. If the sequence optimization processes 14, 15 operate independently of each other, for example, without the coordination process 16, the result is that a hot rolling program in which still hot slabs can be fed from the smelting plant process 11 to the hot rolling process 13 essentially directly, for example, without any appreciable cooling below a further processing temperature of about 1000° C., cannot be carried out, because not all the slabs required for carrying out the specific hot rolling program are available in the temporary store 12 within a specific time period after their manufacture in the smelting plant process 11.

The coordination process 16 triggers the hot-rolling sequence optimization process, in order to allocate to the hot rolling program 2 the two second batches, which were originally allocated to the hot rolling program 1. With this new composition of the hot rolling programs, it is possible to operate the hot rolling program 1 and the hot rolling program 2 in such a way that the slabs can be processed in the hot rolling process while still in the hot state, i.e. without incurring excessive temporary storage time in the temporary store 12. This is represented in the third line of FIG. 3 by the identification “H.” At the same time, the coordination process 16 triggers the smelting-plant sequence optimization process 14, so that this process carries out renewed optimization of the schedule. In this example, the second batch group should be manufactured before the first and third batch groups after renewed optimization of the schedule (see line 4). Then the hot charging ratio can be further improved. All three hot rolling programs are then designed such that the batches can be fed to it in a still hot state (see line 5). The comparison of the results in this example shows how the coordination process 16 can simultaneously trigger the sequence optimization processes 14, 15, so that they carry out renewed optimization of their schedule in order to improve the hot charging ratio.

The created, optimized schedules can then be transferred to the respective process control or process monitoring of the respective manufacturing stages to be implemented and/or carried out and can be implemented and carried out within the actual manufacturing process.

The exemplary embodiments of the present disclosure can be implemented by at least one processor (e.g., general purpose or application specific) of a computer processing device which is configured to execute a computer program tangibly recorded on a non-transitory computer-readable recording medium, such as a hard disk drive, flash memory, optical memory or any other type of non-volatile memory. Upon executing the program, the at least one processor is configured to perform the operative functions of the above-described exemplary embodiments.

The present disclosure also includes any desired combinations of exemplary embodiments and individual refinement features or developments as long as they are not mutually exclusive.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### List of Designations

11 Smelting plant process
12 Temporary store
13 Hot rolling process
14 Smelting-plant sequence optimization process
15 Hot rolling optimization process
16 Coordination process

What is claimed is:

1. A method for at least one of coordinating and operating two successive manufacturing stages of a production process, the method comprising:
a) devising a production schedule of a first of the manufacturing stages according to a first optimization target based on one or more first optimization parameters, in order to obtain a first optimization result;
b) devising a production schedule of a second of the manufacturing stages according to a second optimization target based on one or more second optimization parameters, in order to obtain a second optimization result;
c) assessing the first and second optimization results with regard to an overall optimization target;
d) modifying the first and second optimization parameters; and
e) repeating the devising the production schedules of the first and second manufacturing stages according to the respective first and second optimization targets based on at least one of the modified first and second optimization parameters.

2. The method according to claim 1, comprising:
carrying out c) to e) until an abort criterion is satisfied.

3. The method according to claim 2, wherein the abort criterion corresponds to a maximum number of times that the devising of the production schedules is repeated or being determined by a predetermined overall optimization criterion being reached.

4. The method according to claim 1, comprising:
providing between the manufacturing steps a temporary store for receiving intermediate products of the first manufacturing stage and taking the intermediate products from the temporary store for further processing.

5. The method according to claim 4, wherein the overall optimization target concerns a number of intermediate products in the temporary store, the method comprising at least one of:
reducing an average time period during which the intermediate products are temporarily stored in the temporary store;
maximizing a ratio that dictates a ratio of the number of intermediate products that can be fed to the second manufacturing stage without temporary storage in the temporary store to a total number of intermediate products manufactured; and
minimizing energy consumption for keeping the intermediate products ready.

6. The method according to claim 1, wherein the optimization parameters comprise at least one of the following parameters:
a latest completion date for a batch having one or more end products of the second manufacturing stage;
an earliest date of availability for a batch;
a batch priority;
a weighting of one or more of the optimization targets;
a desired sequence of batch processing;
minimum, maximum or desired sizes of specific batch groups;
a priority of end products to be produced; and
a predetermined optimization parameter.

7. The method according to claim 1, wherein optimizing of the production sequence of the first and second manufacturing stages is carried out in each case by an optimization method which is selected from a group consisting of the following optimization methods:
a mathematical optimization method based on at least one of linear programming, non-linear programming, and mixed integer programming;
a metaheuristic optimization method based on at least one of an evolutionary algorithm, on a particle swarm algorithm, on a tabu search, on algorithms implemented in neural networks, on methods for variable neighbourhood search and/or on an ant colony algorithm;
a randomized optimization method;
a heuristic method, based on at least one of a greedy algorithm, on an insertion heuristic, a construction heuristic and/or a savings heuristic;
a rule-based method; and
a combination of the aforementioned methods.

8. The method according to claim 1, wherein the modifying of the first and second optimization parameters comprises:
applying to the optimization parameter a modification variable which is predetermined or determined from a process variable of at least one of the manufacturing stages.

9. The method according to claim 1, wherein the first manufacturing stage corresponds to a smelting plant process and the second manufacturing stage corresponds to a hot rolling process.

10. An apparatus for at least one of coordinating and operating two successive manufacturing stages of a production process, the apparatus comprising:
a first processor coupled to a memory, configured to devise a production schedule of a first of the manufacturing stages according to a first optimization target based on one or more first optimization parameters, in order to obtain a first optimization result;
a second processor coupled to a memory, configured to devise a production schedule of a second of the manufacturing stages according to a second optimization target based on one or more second optimization parameters, in order to obtain a second optimization result; and
a third processor coupled to a memory, configured as a coordination device for assessing the first and second optimization results with regard to an overall optimization target, for modifying the first and second optimization parameters and for repeating the devising of the production schedules of the first and second manufacturing stages according to the respective first and second optimization targets based on the modified first and/or second optimization parameters.

11. A computer readable medium for non-transitory storing of computer program instructions, which when executed by a processor coupled to a memory programmed with the instructions, will configure the processor to:
a) devise a production schedule of a first of the manufacturing stages according to a first optimization target based on one or more first optimization parameters, in order to obtain a first optimization result;
b) devise a production schedule of a second of the manufacturing stages according to a second optimization target based on one or more second optimization parameters, in order to obtain a second optimization result;
c) assess the optimization results with regard to an overall optimization target;
d) modify the first and second optimization parameters; and
e) repeat devising of the production schedules of the first and second manufacturing stages according to the respective first and second optimization targets based on at least one of the modified first and second optimization parameters.

12. The computer readable medium according to claim 11, configuring the processor to:
carry out c) to e) until an abort criterion is satisfied.

13. The computer readable medium according to claim 12, wherein the abort criterion corresponds to a maximum number of times that the devising of the production schedules is repeated or being determined by a predetermined overall optimization criterion being reached.

14. The computer readable medium according to claim 11, configuring the processor to:
provide a temporary store between the first and second manufacturing stages for receiving intermediate products of the first manufacturing stage and taking the intermediate products from the temporary store for further processing.

15. The computer readable medium according to claim 11, wherein the overall optimization target concerns a number of intermediate products in the temporary store, the processor being configured to:
reduce an average time period during which the intermediate products are temporarily stored in the temporary store;
maximize a ratio that dictates a ratio of the number of intermediate products that can be fed to the second manufacturing stage without temporary storage in the temporary store to a total number of intermediate products manufactured; and
minimize energy consumption for keeping the intermediate products ready.

16. The computer readable medium according to claim 15, wherein the optimization parameters comprise at least one of the following parameters:
a latest completion date for a batch having one or more end products of the second manufacturing stage;
an earliest date of availability for a batch;
a batch priority;
a weighting of one or more of the optimization targets;
a desired sequence of batch processing;
minimum, maximum or desired sizes of specific batch groups;
a priority of end products to be produced; and
a predetermined optimization parameter.

17. The computer readable medium according to claim 11, wherein the processor is configured to optimize the production sequence of the first and second manufacturing stages in each case by an optimization method which is selected from a group consisting of the following optimization methods:
a mathematical optimization method based on at least one of linear programming, non-linear programming, and mixed integer programming;
a metaheuristic optimization method based on at least one of an evolutionary algorithm, on a particle swarm algorithm, on a tabu search, on algorithms implemented in neural networks, on methods for variable neighbourhood search and/or on an ant colony algorithm;
a randomized optimization method;
a heuristic method based on at least one of a greedy algorithm, on an insertion heuristic, a construction heuristic and/or a savings heuristic;
a rule-based method; and
a combination of the aforementioned methods.

18. The computer readable medium according to claim 11, wherein the processor is configured to modify the first and second optimization parameters by:
applying to the optimization parameter a modification variable which is predetermined or determined from a process variable of at least one of the manufacturing stages.

19. The computer readable medium according to claim 11, wherein the first manufacturing stage corresponds to a smelting plant process and the second manufacturing stage corresponds to a hot rolling process.
